(19) United States
(12) Patent Application Publication
(10) Pub. No.: US 2025/0171672 A1
(43) Pub. Date: May 29, 2025

(54) THERMALLY STABLE NANO-ENCAPSULATED PHASE-CHANGE MATERIAL, METHODS FOR PREPARING THE SAME, AND ITS APPLICATIONS

(71) Applicant: Nano and Advanced Materials Institute Limited, Hong Kong (HK)

(72) Inventors: Xiyao ZHANG, Hong Kong (HK); Kang ZHANG, Hong Kong (HK); Christopher Cheung YEC, Hong Kong (HK); Jifan LI, Hong Kong (HK); Lun LOU, Hong Kong (HK); Yuping CHANG, Hong Kong (HK)

(21) Appl. No.: 18/959,698

(22) Filed: Nov. 26, 2024

Related U.S. Application Data
(60) Provisional application No. 63/603,647, filed on Nov. 29, 2023.

(51) Int. Cl. C09K 5/06

(52) U.S. Cl. CPC C09K 5/063

(57) ABSTRACT

The present invention relates to a nano-encapsulated phase-change material (nano-PCM), its preparation method, and its applications thereof. The nano-PCM includes at least one phase change core material; an inner polymeric shell; and an outer inorganic shell. The outer inorganic shell surrounds the inner polymeric shell. The nano-PCM offers enhanced thermal stability, efficient heat transfer, and improved dispersion in materials like fabrics and plastics due to its small size and large surface area. It provides thermal regulation for various products, such as clothing and packaging, by storing and releasing energy to buffer temperature fluctuations. Additionally, nano-PCM outperforms micro-PCM in thermal stability, mechanical performance, and lifespan, making it ideal for high-temperature processes and multiple thermal cycles.

### CROSS-REFERENCE TO RELATED APPLICATION

The present application claims the priority from the U.S. provisional patent application Ser. No. 63/603,647 filed Nov. 29, 2023, and the disclosure of which is incorporated herein by reference in its entirety.

### FIELD OF THE INVENTION

The present invention generally relates to the phase change material. To be specific, the present invention relates to a nano-encapsulated phase-change material, its preparation method, and its applications thereof.

### BACKGROUND OF THE INVENTION

Phase change materials (PCM) can absorb and release thermal energy during their melting and freezing processes, respectively. This transformation of physical properties is known as the phase change process, during which PCM absorbs or releases a large amount of latent heat. A notable feature of the phase change process is its isothermal nature, meaning the temperature remains constant. This characteristic helps to control temperature changes within a smaller range, thereby achieving precise temperature regulation. In contrast, traditional solid or liquid sensible heat storage materials experience temperature changes when absorbing or releasing heat, requiring operation within a larger working temperature range, which results in lower thermal transfer efficiency of the system. In recent years, a novel phase change material has been developed. Encapsulated phase change materials are polymeric composites composed of core PCM materials and micro- or nano-scale shell materials, in which the shell materials are required withstand high and low temperatures and will not be affected by temperature changes, and the core material is an organic substance with a phase transition temperature of-50° C. to 150° C. The encapsulated phase change materials are able to effectively solve the leakage, phase separation and corrosive problems faced by the traditional phase change materials face during use.

Several attempts have been made to microencapsulate phase change materials, for example, the microcapsules phase change materials disclosed in U.S. Pat. No. 10,195,577 and US Patent Publication No. 20100068525. However, conventional microencapsulated phase change materials still have some drawbacks, such as the problems including leakage, poor coating and poor dispersibility, and short service cycle time.

CN Patent Application Publication No. 103191670 discloses a method for preparing low-energy nano-emulsions. However, the morphology of the final product is liquid emulsion.

Wu et al. reported an encapsulated phase-change material, in which ammonium persulfate was used as the initiator. By polymerizing MMA monomer and performing the interfacial hydrolysis of tetraethoxysilane (TEOS), a nano-capsule with paraffin as core and composite PMMA-SiO₂ as shell, along with corresponding mechanism are provided. However, the resulting encapsulated phase-change material has the tendency to burst and has a low heat fusion. In other words, the particle taught by Wu has a low energy storage density (Wu, Xiao Lin, et al. “One-Pot Synthesis of Nano-Capsules with Paraffin as Core and PMMA-SiO₂ as Shell by Interfacial Hydrolysis and Polymerization.” Materials Science Forum. Vol. 722. Trans Tech Publications Ltd, 2012).

Many conventional encapsulated PCM suffer from low thermal stability, leading to performance degradation under extreme temperature conditions. Furthermore, the encapsulation methods used often result in inadequate protection against leakage and phase separation, compromising the overall effectiveness of the materials. Additionally, the energy storage density of these materials tends to be suboptimal, limiting their practical applications. Moreover, the preparation processes can be overly complex, which not only raises production costs but also hinders scalability. Addressing these shortcomings is essential for developing next-generation phase change materials that can meet the demands of modern thermal management applications. Therefore, there is a need in the art for advanced phase change materials that address the limitations of current technologies.

### SUMMARY OF THE INVENTION

To address the above-mentioned shortcomings, a first aspect of the present invention provides a thermally stable nano-encapsulated phase-change material (nano-PCM), which includes at least one phase change core material and bilayer shells. The bilayer shells include an inner polymeric shell containing at least one polymer material and an outer inorganic shell containing an inorganic material. The outer inorganic shell surrounds the inner polymeric shell. The formation of the outer inorganic shell enhances thermal stability of the thermally stable nano-encapsulated phase-change material. The nano-encapsulated phase-change material maintain thermal stability at temperatures exceeding 200° C.

In accordance with one embodiment, a mass ratio between the at least one phase change core material and the shell materials is 5-15:10, and a mass ratio between the at least one polymer material and the inorganic material is 5-15:10.

In accordance with one embodiment, the at least one phase change core material is one or more selected from light paraffin, 25 #phase change paraffin, 30 #phase change paraffin, 35 #paraffin, C₁₂₋₂₈ n-alkane, C₈₋₁₈ fatty alcohols, C₈₋₁₈ fatty acids and/or ester thereof, or a combination thereof.

In accordance with one embodiment, the nano-PCM has a particle size ranging between 50 and 500 nm and a heat of fusion of at least 50 J/g.

In accordance with one embodiment, the inner polymeric shell includes polystyrene, polymethylstyrene, polymethyl methacrylate (PMMA), polybutyl acrylate (PBA), polyvinyltoluene, polymethacrylic acid and polyacrylic acid, or any combination and/or copolymer thereof.

In accordance with one embodiment, the outer inorganic shell includes silicon dioxide (SiO₂) from a hydrolysis reaction of tetraethyl orthosilicate in an ethanol aqueous solution.

A second aspect of the present invention provides a one-pot synthesis method for producing the thermally stable nano-PCM. The method includes mixing at least one phase change core material with a plurality of non-phase change materials including at least one monomer, an initiator, a crosslinker, and at least one hydrophobic surfactant to form a hydrophobic mixture; heating the hydrophobic mixture at a temperature higher than a melting point of the hydrophobic mixture; dropping an aqueous mixture containing water and at least one hydrophilic surfactant into the hydrophobic mixture to form a nano-emulsion; heating the nano-emulsion to form the inner polymer shell encapsulated phase-change material; and adding an outer shell precursor material and reacting to form the outer inorganic shell over the inner polymer shell to form the nano-PCM with bilayer shells.

In accordance with one embodiment, the at least one phase change core material is in an amount of 100-500 parts by weight of the hydrophobic mixture. The plurality of non-phase change materials includes 100-500 parts by weight of monomer; 1-5 parts by weight of initiator; 10-50 parts by weight of crosslinker; 100-500 parts by weight of surfactant; and 1000-6000 parts by weight of water after low energy emulsification and polymerization.

In accordance with one embodiment, wherein the outer shell precursor material includes: 100-1000 parts by weight of TEOS; 100-1000 parts by weight of ethanol; and 500-6000 parts by weight of water.

In accordance with one embodiment, the crosslinker is selected from one or more of allyl methacrylate (AMA), benzoyl peroxide (BPO), dicumyl peroxide (DCP), dimethyl 3,3′-dithiobispropionimidate (DTBP), or 3-(3,5-di-tert-butyl-4-hydroxyphenyl) propionic acid (DBHP).

In accordance with one embodiment, the at least one monomer includes styrene, alpha-methylstyrene, methyl methacrylate (MMA), butyl acrylate (BA), vinyltoluene, methyl ester, methacrylic acid and acrylic acid, or a combination thereof.

In accordance with one embodiment, the initiator includes ammonium persulfate, potassium persulfate, t-butyl hydroperoxide, and 2.2′-azobisisobutyronitrile (AIBN), or a combination thereof.

In accordance with one embodiment, the at least one hydrophobic surfactant includes sorbitan esters, alkyl polyethoxylates (AEO), alkylphenol polyethoxylated (APEO), or a combination thereof.

In accordance with one embodiment, the at least one hydrophilic surfactant includes cetrimonium bromide (CTAB), sodium dodecyl sulfate (SDS), polysorbate, sodium dodecylbenzenesulfonate (SDBS), or a combination thereof.

In accordance with one embodiment, the formation of the inner polymer shell and the outer inorganic shell is under a temperature ranging between 6° and 80° C.

A third aspect of the present invention provides a thermal regulating filament including a solid polymer matrix material and the thermally stable nano-PCM dispersed therein. The thermal regulating filament has a tensile strength ranging from 100-400 MPa, and an elongation rate of 40% to 170%.

In accordance with one embodiment, the solid polymer matrix material includes at least one of polyethylene terephthalate (PET), polyamide (PA), polyacrylonitrile (PAN), polyethylene alcohol (PVA), polyethylene (PE) or polyvinyl chloride (PVC).

In accordance with one embodiment, a mass ratio between the thermally stable nano-PCM and the solid polymer matrix material is 1-50:100.

In accordance with one embodiment, the thermal regulating filament has a diameter ranging from 5 μm to 50 μm and a heat of fusion of at least 10 J/g.

In accordance with one embodiment, the thermal regulating filament is made by the method including mixing the nano-encapsulated phase-change material with a polymer melt to form a mixture; extruding and spinning the mixture into a filament with a die diameter of 0.1-0.5 mm; and winding extruded filament with a winding unit at a winding speed of 1-10 m/min and a winding torque of 10-100 Nm to form the thermal regulating filament.

In accordance with one embodiment, the mass ratio between the nano-PCM and the polymer melt is 1-50:100.

In accordance with one embodiment, the polymer melt is made by a process including: pre-drying one or more polymer pellets at 60-90° C. for at least 10 hours before use; and adding the one or more polymer pellets into a high torque twin-screw compounder, with barrel temperatures set above a melting temperature of the polymer and a screw speed set at 10-100 rpm.

In accordance with one embodiment, the filament is drawn using a conditioning unit with a draw ratio of 1 to 5 times, and at a draw temperature of 60-90° C., followed by annealing the drawn filament at 150-250° C. to obtain the thermal regulating filament.

A fourth aspect of the present invention provides a composite material including a solid material or a liquid material and the thermally stable nano-PCM dispersed therein.

In accordance with one embodiment, the solid material or the liquid material includes polyurethane (PU), poly (methyl methacrylate) (PMMA), acrylonitrile butadiene styrene (ABS), polyamide (PA), polycarbonate (PC), polyformaldehyde (POM), polypropylene (PP), polystyrene (PS), polyethylene (PE) and silicon rubber.

In accordance with one embodiment, a mass ratio between the thermally stable nano-PCM and the solid material or the liquid material is 1-100:100.

In accordance with one embodiment, the composite material is made by mixing the thermally stable nano-PCM with the solid material or the liquid material at a temperature between 10° C. to 300° C. to obtain a mixture; chilling and pelletizing the mixture into pellets; and molding or injection molding the pellets to obtain the composite material. The mixing process is performed in an open mill compactor, an internal mixer, compression molding machine or an extruder.

The present invention offers significant advantages over current micro-PCM products. As a thermal storage medium, nano-PCM can achieve more efficient heat transfer between the PCM nanoparticles and their surroundings due to their smaller size and larger specific surface area. The bilayer structure of nano-PCM shows significant thermal stability even at high temperatures exceeding 200° C., allowing them to be processed using methods such as melt spinning. The nano-sized distribution and its excellent mechanical performance enables uniform dispersion in other matrix materials, such as fabrics and plastics. In particular, they allow for dispersion in long, thin filaments with a smooth surface.

Moreover, it can be reused for heating-cooling cycles, resulting in a significantly longer service life compared to other thermal storage materials. With these advantages, along with a broader range of available fabric materials, this technique will significantly enhance the thermal and physical comfort of fabric products.

### BRIEF DESCRIPTION OF THE DRAWINGS

In order to clearly illustrate the technical solutions of the embodiments of the present invention, the drawings needed to be used in the description of the embodiments will be briefly introduced below. It is obvious that the drawings in the following description are only some embodiments of the present invention, and it is obvious for those skilled in the art to obtain other drawings based on these drawings without inventive exercise, in which:

FIG. 1 shows a schematic diagram of a thermally stable nano-PCM according to an embodiment of the present invention;

FIG. 2 shows the particle size distribution of the thermally stable nano-PCM;

FIG. 3 shows the differential scanning calorimetry (DSC) spectrum of the thermally stable nano-PCM;

FIG. 4A shows a scanning electron microscope (SEM) image of the thermally stable nano-PCM in accordance with one embodiment of the present invention. FIG. 4B shows a transmission electron microscope (TEM) image of the thermally stable nano-PCM in accordance with one embodiment of the present invention;

FIG. 5 shows a temperature-weight ratio curve of the samples with different shells;

FIG. 6 shows nano-PCM Nylon filaments according to an embodiment of the present invention;

FIG. 7A shows nano-PCM fabrics according to an embodiment of the present invention.

FIG. 7B shows a microscope photo of the nano-PCM fabrics;

FIG. 8 shows the tensile stress of nano-PCM Nylon filaments with various diameters at different nominal strains;

FIG. 9 shows the DSC spectrum of the nano-PCM Nylon filaments in accordance with one embodiment of the present invention;

FIG. 10 shows three nano-PCM silicon composites (right angle silicone, flocking silicone, high elastic silicone with nano-PCM) according to an embodiment of the present invention; and

FIG. 11A shows the density of silicone and silicon with varying nano-PCM ratios. FIG. 11B shows the shore A hardness of right angle silicone, flocking silicone, and high elastic silicone with nano-PCM. FIG. 11C shows the latent heat of right angle silicone, flocking silicone, and high elastic silicone with nano-PCM.

### DETAILED DESCRIPTION OF THE INVENTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variations and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

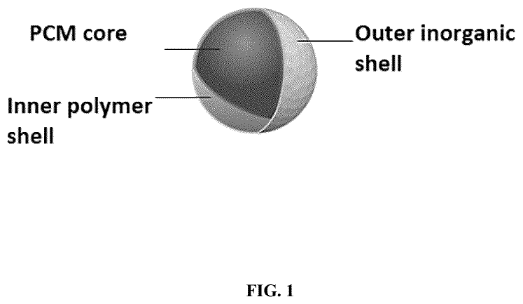

In a first aspect of the present invention provides a thermally stable nano-PCM, which includes at least one phase change core material and bilayer shells (outer inorganic shell and inner polymer shell), as shown in FIG. 1. The inner polymer keeps encapsulation compactness and provides synthetic template, and the inorganic shell improves mechanical strength and thermal stability. Importantly, the thermal stability of the nano-PCM is significantly increased when forming the outer inorganic shell. The formation of an outer shell on the nano-PCM significantly enhances its thermal stability. The nano-PCM maintains thermal stability at temperatures exceeding 200° C.

The phase-change core material includes, but is not limited to, light paraffin, 25 #phase change paraffin, 30 #phase change paraffin, 35 #paraffin, C₁₂₋₂₈ n-alkane, C₈₋₁₈ fatty alcohols, C₈₋₁₈ fatty acids and/or ester thereof, or a combination thereof. The term “number #” means a melting temperature of the phase change core material. For example, 25 #indicates the melting temperature of phase change core material is 25° C.

The inner polymeric shell may include polystyrene, polymethylstyrene, polymethyl methacrylate, polybutyl acrylate, polyvinyltoluene, polymethacrylic acid and polyacrylic acid, or any combination and/or copolymer thereof. The outer inorganic shell may include silicon dioxide (SiO₂), from a hydrolysis reaction of tetraethyl orthosilicate in an ethanol aqueous solution.

In an embodiment, the mass ratio between the phase change core material and the non-phase change shell material is 5-15:10. The non-phase change shell material includes at least one polymer material forming the inner polymeric shell, and an inorganic material forming the outer inorganic shell.

Conventionally, the preparation of phase change material nano-emulsion undergoes a high-energy emulsification process which relies on a mechanical force (high pressure homogenizer) to achieve its desired particle size. However, the high-energy emulsification often has poor yields and is suitable for small scale production, like in a research laboratory.

The bilayer shells of the present invention are formed by low energy emulsification followed by polymerization of a mixture of the phase change core material and the non-phase change shell materials in water.

The method described below adopts the low energy emulsification step based on phase inversion, driven by chemical forces, to prepare a high-concentration nano-emulsion of the phase change core material. This approach offers the advantage of high yield. The resulting phase change material nano-emulsion can be easily scaled-up to an industrial scale. Furthermore, the polymerization and encapsulation process are made by in-situ, one-pot polymerization.

More specifically, the method for mass producing the thermally stable nano-PCM s starts with pre-mixing. The phase change core material and certain non-phase change materials, including at least one monomer, an initiator, a crosslinker, and at least one hydrophobic surfactant, are mixed to form a hydrophobic mixture. Next, the hydrophobic mixture is heated to a temperature higher than a melting point of the mixture with constant stirring at 100-500 rpm for a period of time until a clear and homogenous hydrophobic mixture forms. Similarly, hydrophilic components, such as hydrophilic surfactants, are added into water to form an aqueous mixture. Then, the low energy emulsification process is conducted. The aqueous mixture is added in a constant drop-wise flow to the hydrophobic mixture. The emulsification is performed using a magnetic stirrer (or other suitable low-energy emulsification equipment, such as a low-shear mixer) at a temperature of 10-80° C., with a stirring speed of 100-500 rpm for 15-30 minutes. The ratio of the aqueous phase to the organic phase is maintained at 1-3:1 to achieve optimal droplet size distribution. After that, nano-emulsions are formed. The low energy emulsification process produces small and uniform droplet size template for the subsequent polymerization.

In the second stage of the producing method, an inner shell is formed and encapsulated each nano droplet via polymerization and crosslinking of monomers. The polymerization is carried out at 60-80° C. with continuous stirring for 4-6 hours to ensure complete shell formation, resulting in uniform bilayer encapsulation. During the period, a constant stirring at 300-600 rpm and an inert gas atmosphere are required to obtain the thermally stable nano-PCM particle with an uniform particle size of about 50-500 nm. The inert gas may be sealed nitrogen.

In the third stage, an outer inorganic shell is formed via a sol-gel reaction from a precursor material. The precursor material of the outer inorganic shell may include TEOS. It is a compound often used as a precursor for producing silica in materials science and chemistry. TEOS undergoes hydrolysis and polycondensation reactions to form silica, which can be used to create thin films, coatings, or as a component in various materials, including the outer shells of microcapsules in encapsulation technologies.

The crosslinker may be selected from one or more of allyl methacrylate (AMA), benzoyl peroxide (BPO), dicumyl peroxide (DCP), dimethyl 3,3′-dithiobispropionimidate (DTBP), or 3-(3,5-di-tert-butyl-4-hydroxyphenyl) propionic acid (DBHP). The monomer may include but not limited to styrene, alpha-methylstyrene, methyl methacrylate (MMA), butyl acrylate (BA), vinyltoluene, methyl ester, methacrylic acid and acrylic acid, or a combination thereof.

The initiator may include but not limited to ammonium persulfate, potassium persulfate, t-butyl hydroperoxide, and 2.2′-azobisisobutyronitrile, or a combination thereof.

The surfactant may include but not limited to polysorbate, sorbitan esters, cetrimonium bromide, and alkyl polyethoxylate, or a combination thereof. The surfactants are temperature sensitive.

In one embodiment, the phase change core material is in an amount of 100-500 parts by weight of the mixture of the phase change core material and the non-phase change materials of the shell. The non-phase change materials may include the monomer in 100-500 parts by weight of the mixture, the initiator in 1-5 parts by weight of the mixture, the crosslinker in 10-50 parts by weight of the mixture, surfactant in 100-500 parts by weight of the mixture, and water in 1000-6000 parts by weight of the mixture after the low energy emulsification and polymerization.

Notably, the thermally stable nano-encapsulated PCM surpasses micro-PCM products in terms of:

(1) The nano-PCM can achieve more efficient heat transfer between the PCM nanoparticles and the surroundings due to their smaller size (50-500 nm), and an increased specific surface area, which significantly enhances thermal conductivity compared to bulk PCM materials.

(2) The bilayer structure of nano-PCM particles maintain thermal stability under high temperatures exceeding 200° C., allowing them to be processed by high-temperature processes such as the melting spinning.

(3) The nano-sized distribution enables uniform dispersion in other matrix materials such as fabrics and plastics. Its good mechanical performance, with a tensile strength of 100-400 MPa and elongation at break of 40-170%, allows for the dispersion in long and thin filaments with diameters as small as 5-50 micrometers, resulting in a smooth surface.

(4) It can be reused for many heating-cooling cycles, typically withstanding up to 1000 cycles, while retaining a much longer service life compared to other thermal storage materials, with only a 10% decrease in efficiency after 1000 cycles.

(5) The conventional microcapsule phase change material has a high tendency to break and phase separation after ultra-sonic water bath. The breakage of the conventional microcapsule phase change material particle is naked-eye visible. The same applies to the phase separation. However, in contrast, the thermally stable nano-PCM of the present invention keeps stable after the same treatment (ultra-sonic water bath for 10 minutes). With these advantages, coupled with a broader array of fabric materials, this technique will significantly improve the thermal and physical comfort of fabric products.

When the thermally stable nano-PCM is used together with other materials to make a product. The final product exhibits an effective buffer balancing heat against ambient temperature fluctuations. For example, the thermally stable nano-PCM is used together with other materials to make a filament, a fabric, etc. For example, the thermal comfort in clothing can be improved. The thermal transfer efficiency is also increased.

The present invention also provides a thermal regulating filament, which includes a solid polymer matrix material and the thermally stable nano-PCM dispersed therein. A mass ratio between the thermally stable nano-PCM and the solid polymer matrix material is 1-50:100. The prepared thermal regulating filament has a diameter ranging from 5 μm to 50 μm and a heat of fusion of 10 J/g or greater. The thermal regulating filament has a tensile strength ranging from 100-400 MPa, and an elongation rate of 40% to 170%.

In one embodiment, the solid polymer matrix material may include, but is not limit to, polyethylene terephthalate (PET), polyamide (PA), polyacrylonitrile (PAN), polyethylene alcohol (PVA), polyethylene (PE) or polyvinyl chloride (PVC), or a combination thereof.

More specifically, the thermal regulating filament is made by the method includes incorporating the nano-PCM into a polymer melt and extruding, followed by spinning. First, the polymer pellets are pre-dried at 60-90° C. for at least 10 hours before use, and then added into a high torque twin-screw compounder with barrel temperatures above the melting temperature of the polymer and a screw speed set at 10-100 rpm. Next, the nano-PCM is added into the compounder. The extrusion is then performed to obtain an extruded composite with a die diameter of 0.1-0.5 mm, where a mass ratio between the nano-PCM and the pre-dried polymer pellets is 1-50:100.

In one embodiment, the extruded composite is winded with a winding unit at a winding speed of 1-10 m/min and a winding torque of 10-100 Nm to form the as-spun filament. The as-spun filament is drawn by a conditioning unit with a draw ratio of 1-5x, and a draw temperature of 60-90° C., and the drawn filament is annealed at 150-250° C. to obtain the thermal regulating filament.

Furthermore, the present invention also provides a composite material, which includes a solid material or a liquid material and the thermally stable nano-PCM dispersed therein. A mass ratio between the thermally stable nano-PCM and the solid material or the liquid material is 1-100:100.

In one embodiment, the solid material or the liquid material may include PU, Poly PMMA, ABS, PA, PC, POM, PP, PS, PE and silicon rubber.

The composite material is prepared by the following steps: dispersing the burst-resistant, thermally stable nano-PCM in a water-based solid material or a liquid material. Next, chilling and pelletizing the mixture into pellets, and molding or injection molding the pellets to obtain the composite material.

The thermally stable nano-PCM and the solid material or the liquid material are mixed in a weight ratio of 1-100:100.

In one embodiment, the mixing process is performed in an open mill compactor, an internal mixer, compression molding machine or an extruder.

The following examples illustrate the present invention and are not intended to limit the same.

### EXAMPLE

### Example 1—Characteristics of the Thermally Stable Nano-PCM

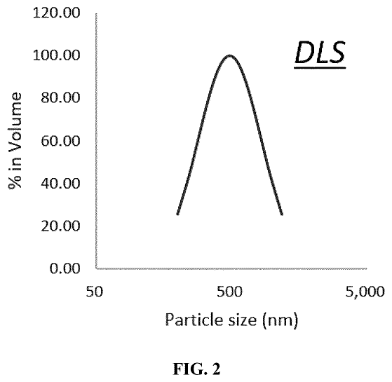

Dynamic Light Scattering (DLS) is a technique used in physics and chemistry to analyze the size and motion of particles in a solution by measuring the fluctuations in light scattering. The particle size distribution plot is shown as the % in volume against particle size in nanometer. FIG. 2 shows that the thermally stable nano-PCM has a mean particle size in a range of 300 nm to 900 nm after the low-energy emulsification and polymerization process.

Preferably, the thermally stable nano-PCM has a mean particle size in a range of 300 nm to 600 nm. More preferably, the thermally stable nano-PCM has a mean particle size at 388 nm.

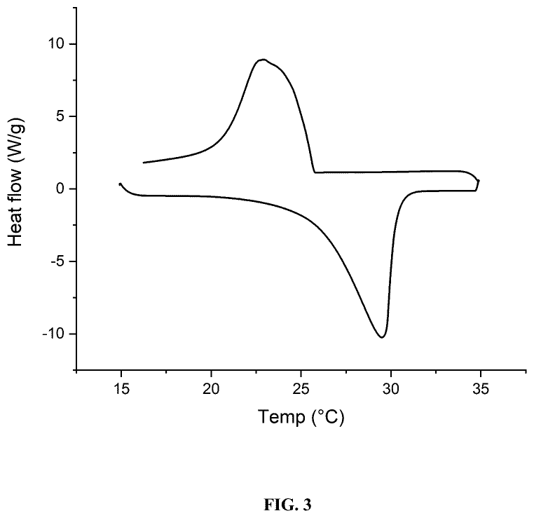

A DSC spectrum of the thermally stable nano-PCM is shown in FIG. 3. The x-axis indicates the temperature in degree Celsius, and the y-axis indicates the heat flow (W/g). Heat fusion indicates the amount of energy required to change the thermally stable nano-PCM from a solid to a liquid state. A calculated latent heat value of the nano-PCM can be obtained from the results of the DSC spectrum. As shown in FIG. 3, the thermally stable nano-PCM is prepared with a latent heat of 78.33 J/g at 25-30° C. with a supercooling degree at 0.01° C.

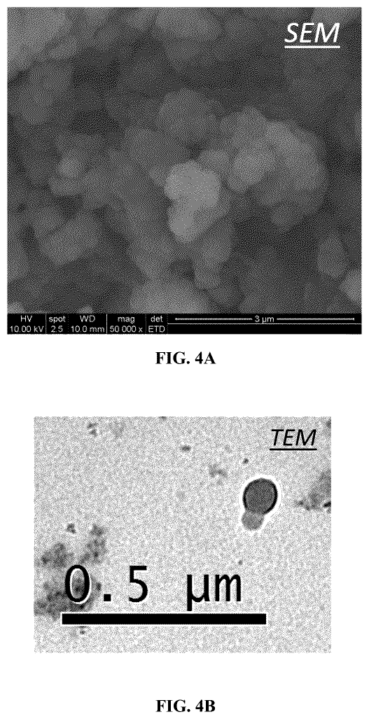

FIGS. 4A-4B show a SEM image and a TEM image of thermally stable nano-PCM. It could be seen that the nano-PCM s have a uniform particle size, ranging between 50 and 500 nm. In general, any individual nano-PCM has a particle size less than 500 nm.

### Example 2—Composition of the Thermally Stable Nano-PCM

Table 1 lists the components of different thermally stable nano-PCMs.

TABLE 1

| Component | PCM 1 | | PCM2 | |
|---|---|---|---|---|
| Phase change | Hexadecane | 100 parts by | Octadecane | 100 parts by |
| core material | | weight | | weight |
| Monomer | styrene | 100 parts by | Styrene/methyl | 100 parts by |
| | | weight | methacrylate (1:1) | weight |
| Initiator | AIBN | 1 part by weight | AIBN | 1 part by weight |
| Crosslinker | Allyl Methacrylate | 10 parts by | Allyl Methacrylate | 10 parts by |
| | (AMA) | weight | (AMA) | weight |
| Hydrophobic | Span 80 | 20 parts by | Span 80 | 20 parts by |
| Surfactant | | weight | | weight |
| Hydrophilic | CTAB | 20 parts by | Tween 80 | 25 parts by |
| Surfactant | | weight | | weight |
| Water | — | 1000 parts by | — | 1000 parts by |
| | | weight | | weight |
| Out shell | TEOS/ethanol (1:1) | 100 parts by | TEOS/ethanol | 200 parts by |
| precursor | | weight | (1:1) | weight |

The synthesis process of the thermally stable nano-PCM1 includes: (1) mixing 100 parts by weight of hexadecane with a plurality of non-phase change materials containing the 100 parts by weight of styrene, 1 part by weight of AIBN, 10 parts by weight of AMA, and the 20 parts by weight of Span 80 to form a hydrophobic mixture; (2) keeping the hydrophobic mixture at a temperature of 25° C.; (3) dropping an aqueous mixture containing 1000 parts by weight of water and 20 parts by weight of CTAB into the hydrophobic mixture to form a nano-emulsion at a constant speed at 5 ml/min and a stirring of 300 rpm; (4) keeping the above nano-emulsion at 70° C. for 5 hours to form the inner polymer shell under a sealed nitrogen atmosphere; and (5) adding 100 parts by weight of TEOS/ethanol (1:1) to above solution and heating at 70° C. for 5 hours to form the outer inorganic shell over the inner polymer shell to form the nano-PCM with bilayer shells.

The synthesis process of the thermally stable nano-PCM2 includes: (1) mixing 100 parts by weight of hexadecane with a plurality of non-phase change materials containing the 100 parts by weight of styrene/methyl methacrylate (1:1), 1 part by weight of AIBN, 10 parts by weight of AMA, and the 20 parts by weight of Span 80 to form a hydrophobic mixture; (2) keeping the hydrophobic mixture at a temperature of 40° C.; (3) dropping an aqueous mixture containing 1000 parts by weight of water and 25 parts by weight of Tween 80 into the hydrophobic mixture to form a nano-emulsion at a constant speed at 5 ml/min and a stirring of 300 rpm; (4) keeping the above nano-emulsion at 70° C. for 5 hours to form the inner polymer shell under a sealed nitrogen atmosphere; and (5) adding 200 parts by weight of TEOS/ethanol (1:1) to above solution and heating at 70° C. for 5 hours to form the outer inorganic shell over the inner polymer shell to form the nano-PCM with bilayer shells.

### Example 4—Thermal Stability of the Nano-PCM with Different Shell

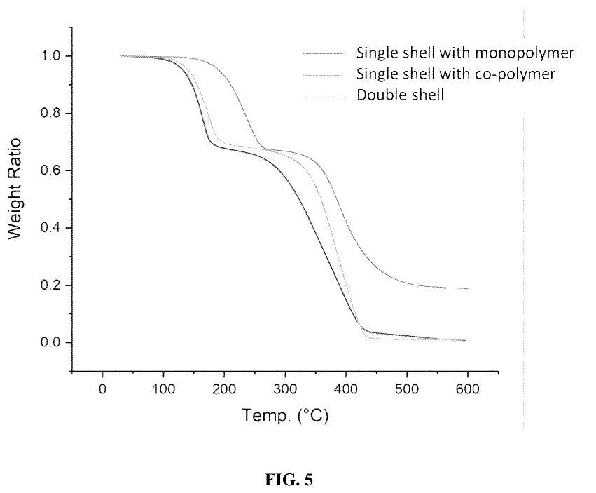

Referring to FIG. 5, three thermally stable nano-PCMs are prepared. The thermal stability temperature of the double-layer shell is increased by about 80 degrees compared with the single-layer shell.

### Example 5

### Fabrication of a Thermal Regulating Filament

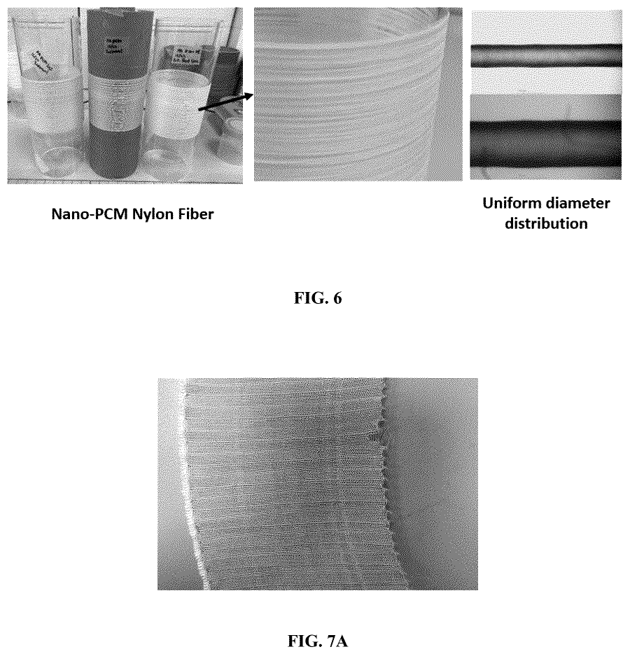

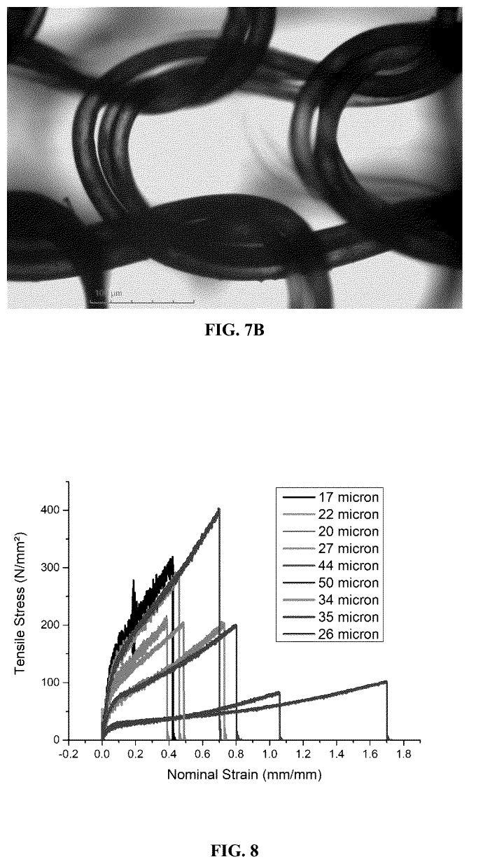

Referring to FIG. 6 and FIGS. 7A-7B, the nano-PCM Nylon filaments are presented, which can be linear or arranged in an interlaced fashion to form a fabric.

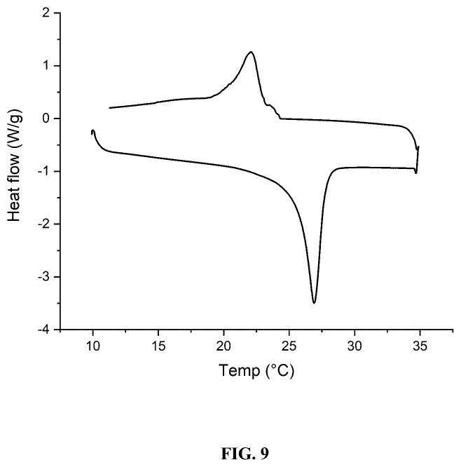

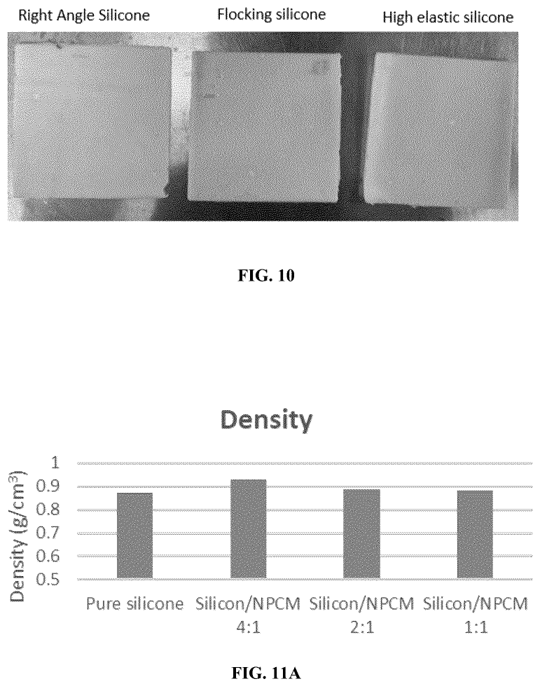

Referring to FIG. 8, the nano-PCM filaments with different diameters ranging from 17-26 microns are tested. The results showed that the nano-PCM filaments had a tensile strength in a range of 100-400 MPa, and an elongation rate of 40% to 170%. The prepared nano-PCM filaments had a latent heat at 16.07 J/g (FIG. 9).

### Example 6

### Fabrication of a Composite Material

A nano-PCM composite material can be formed by processing the PCM material and the polymer matrix. The processing could be blending, extruding, molding, etc. For example, nano PCM silicon composites with different silicone are provided. FIG. 10 shows three different types of nano-PCM silicon composites, which include right angle silicone, flocking silicone, and high elastic silicone, all incorporating nano-PCM. The right angle silicone composite has a higher latent heat capacity, making it ideal for applications requiring sustained thermal regulation. The flocking silicone panel, while softer, offers moderate heat storage, and the high elastic silicone composite, with its superior elasticity, shows a balanced combination of flexibility and thermal stability. These composites illustrate an application of nano-PCM, providing a comparison of material properties, providing a comparison of material properties based on the silicone matrix type, including their thermal storage and mechanical properties.

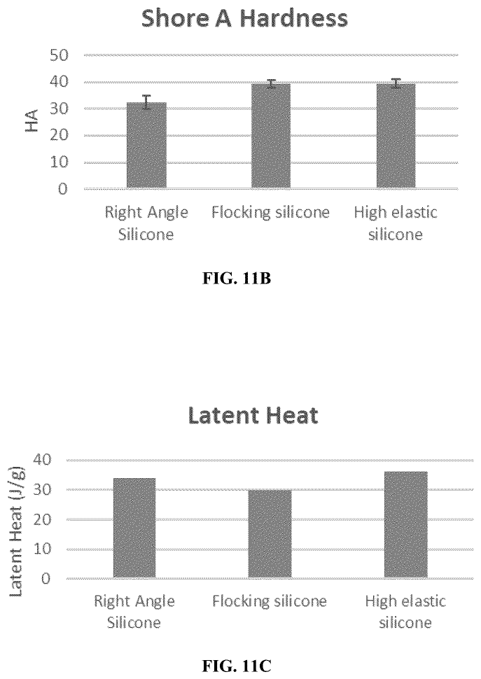

The physical properties (e.g., density, Shore A hardness and latent heat) of the nano PCM silicon panels are also tested, as shown in FIGS. 11A-11C. FIG. 11A shows the density of silicone and silicone-based composites with varying ratios of nano-PCM. The results show the density of silicone and silicone-based composites with varying ratios of nano-PCM. For example, the density increases as the nano-PCM content rises from 10% to 30%. At 10% nano-PCM, the silicone composite has a density of approximately 1.1 g/cm³, while at 30% nano-PCM, the density increases to around 1.25 g/cm³. This indicates that higher nano-PCM content leads to denser composites, which could affect both thermal conductivity and mechanical performance. FIG. 11B shows the Shore A hardness of right angle silicone, flocking silicone, and high elastic silicone with nano-PCM. For instance, the right angle silicone composite shows a Shore A hardness of 70, while the flocking silicone composite demonstrates a lower hardness value of around 60, indicating its softer texture. In contrast, the high elastic silicone with nano-PCM exhibits a hardness of 65, reflecting its balance between flexibility and hardness. These variations highlight the influence of nano-PCM on the mechanical properties of different silicone types. FIG. 11C shows the latent heat values of right angle silicone, flocking silicone, and high elastic silicone composites with nano-PCM. The right angle silicone demonstrates the highest latent heat value of 50 J/g, followed by the high elastic silicone at 45 J/g, and the flocking silicone composite at 40 J/g.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

### INDUSTRIAL APPLICABILITY

Nano-PCM particles are capable of providing an effective buffer against ambient temperature fluctuations in numerous products, such as clothing, bedding, and shoes. For example, nano-PCM in fabrics interacts constantly with the microclimate of the human body, storing and releasing energy to balance body temperature and promote comfort. Additionally, they can be included in packaging materials to maintain the cargo's temperature throughout transportation without affecting the amount of available space.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “nano-encapsulated phase-change material” used in the present invention refers to a phase-change material encapsulated within a bilayer shell structure at the nano-scale. The core contains a material capable of absorbing and releasing thermal energy during phase transitions, while the bilayer shell provides structural integrity, thermal stability, and improved dispersion in various matrices.

The term “bilayer shell” used in the present invention refers to a two-layer encapsulation structure including an inner polymeric shell and an outer inorganic shell. The inner polymeric shell is a polymer-based layer that tightly encapsulates the phase-change core material. The outer inorganic shell is an inorganic layer, such as silicon dioxide, formed through hydrolysis and condensation reactions, designed to enhance mechanical strength and thermal stability.

The term “low energy emulsification” used in the present invention refers to a process for forming emulsions driven primarily by chemical forces, such as phase inversion, rather than mechanical energy. This method requires minimal mechanical input, operates at lower temperatures (10° C. to 80° C.), and produces uniform nano-emulsions with high yield, making it suitable for industrial-scale production.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

What is claimed is:

1. A thermally stable nano-encapsulated phase-change material, wherein the thermally stable nano-encapsulated phase-change material comprising:
at least one phase change core material; and
bilayer shells, comprising of:
an inner polymeric shell comprising at least one polymer material; and
an outer inorganic shell comprising an inorganic material,
wherein the outer inorganic shell surrounds the inner polymeric shell, and wherein the formation of the outer inorganic shell enhances thermal stability of the thermally stable nano-encapsulated phase-change material, and the thermally stable nano-encapsulated phase-change material exhibits thermal stability at temperatures exceeding 200° C.

2. The thermally stable nano-encapsulated phase-change material of claim 1, wherein a mass ratio between the at least one phase change core material and shell materials is 5-15:10, and a mass ratio between the at least one polymer material and the inorganic material is 5-15:10.

3. The thermally stable nano-encapsulated phase-change material of claim 1, wherein the at least one phase change core material is one or more selected from paraffins, C₁₂₋₂₈ alkane, C₈₋₁₈ fatty alcohols, C₈₋₁₈ fatty acids and/or ester thereof, or a combination thereof.

4. The thermally stable nano-encapsulated phase-change material of claim 1, wherein the nano-encapsulated phase-change material has a particle size ranging between 50 and 500 nm and a heat of fusion of at least 50 J/g.

5. The thermally stable nano-encapsulated phase-change material of claim 1, wherein the inner polymeric shell comprises polystyrene, polymethylstyrene, polymethyl methacrylate (PMMA), polybutyl acrylate (PBA), polyvinyltoluene, polymethacrylic acid, polyacrylic acid, or any combination and/or copolymer thereof.

6. The thermally stable nano-encapsulated phase-change material of claim 1, wherein the outer inorganic shell comprises silicon dioxide from a hydrolysis reaction of tetraethyl orthosilicate in an ethanol aqueous solution.

7. A one-pot synthesis method for producing the thermally stable nano-encapsulated phase-change material of claim 1, comprising:
mixing at least one phase change core material with a plurality of non-phase change materials comprising at least one monomer, an initiator, a crosslinker, and at least one hydrophobic surfactant to form a hydrophobic mixture;
heating the hydrophobic mixture at a temperature higher than a melting point of the hydrophobic mixture;
dropping an aqueous mixture comprising water and at least one hydrophilic surfactant into the hydrophobic mixture to form a nano-emulsion;
heating the nano-emulsion to form the inner polymer shell encapsulated phase-change material; and
adding an outer shell precursor material and reacting to form the outer inorganic shell over the inner polymer shell to form the nano-encapsulated phase-change material with bilayer shells.

8. The method of claim 7, wherein the at least one phase change core material is in an amount of 100-500 parts by weight of the hydrophobic mixture, and the plurality of non-phase change materials comprise:
100-500 parts by weight of monomer;
1-5 parts by weight of initiator;
10-50 parts by weight of crosslinker;
100-500 parts by weight of surfactant; and
1000-6000 parts by weight of water.

9. The method of claim 7, wherein the outer shell precursor material comprises:
100-1000 parts by weight of tetraethoxysilane (TEOS);
100-1000 parts by weight of ethanol; and
500-6000 parts by weight of water.

10. The method of claim 7, wherein the crosslinker is selected from one or more of allyl methacrylate (AMA), benzoyl peroxide (BPO), dicumyl peroxide (DCP), dimethyl 3,3′-dithiobispropionimidate (DTBP), or 3-(3,5-di-tert-butyl-4-hydroxyphenyl) propionic acid (DBHP), or a combination thereof.

11. The method of claim 7, wherein the at least one monomer comprises styrene, alpha-methylstyrene, methyl methacrylate (MMA), butyl acrylate (BA), vinyltoluene, methyl ester, methacrylic acid and acrylic acid, or a combination thereof.

12. The method of claim 7, wherein the initiator comprises ammonium persulfate, potassium persulfate, t-butyl hydroperoxide, and 2.2′-azobisisobutyronitrile (AIBN), or a combination thereof.

13. The method of claim 7, wherein the at least one hydrophobic surfactant comprises sorbitan esters, alkyl polyethoxylates (AEO), alkylphenol polyethoxylated (APEO), or a combination thereof.

14. The method of claim 7, wherein the at least one hydrophilic surfactant comprises cetrimonium bromide (CTAB), sodium dodecyl sulfate (SDS), polysorbate, sodium dodecylbenzenesulfonate (SDBS), or a combination thereof.

15. A thermal regulating filament comprising a solid polymer matrix material and the thermally stable nano-encapsulated phase-change material of claim 1 dispersed therein, wherein the thermal regulating filament has a tensile strength ranging from 100-400 MPa, and an elongation rate of 40% to 170%.

16. The thermal regulating filament of claim 15, wherein the solid polymer matrix material comprises at least one of polyethylene terephthalate (PET), polyamide (PA), polyacrylonitrile (PAN), polyethylene alcohol (PVA), polyethylene (PE) or polyvinyl chloride (PVC), or a combination thereof.

17. The thermal regulating filament of claim 15, wherein a mass ratio between the thermally stable nano-encapsulated phase-change material and the solid polymer matrix material is 1-50:100.

18. The thermal regulating filament of claim 15, wherein the thermal regulating filament has a diameter ranging from 5 μm to 50 μm and a heat of fusion of at least 10 J/g.

19. The thermal regulating filament of claim 15, wherein the thermal regulating filament is made by a process comprising:
mixing the nano-encapsulated phase-change material with a polymer melt to form a mixture, wherein a mass ratio between the nano-encapsulated phase-change material and the polymer melt is 1-50:100;
extruding and spinning the mixture into a filament with a die diameter of 0.1-0.5 mm; and
winding extruded filament with a winding unit at a winding speed of 1-10 m/min and a winding torque of 10-100 Nm to form the thermal regulating filament.

20. The thermal regulating filament of claim 19, wherein the filament is drawn using a conditioning unit with a draw ratio of 1 to 5 times, and at a draw temperature of 60-90° C., followed by annealing the drawn filament at 150-200° C. to obtain the thermal regulating filament.
